(19) United States
(12) Patent Application Publication
(10) Pub. No.: US 2024/0045204 A1
(43) Pub. Date: Feb. 8, 2024

(54) AUGMENTING VEHICLE INDICATOR LIGHTS WITH ARHUD FOR COLOR VISION IMPAIRED

(71) Applicant: GM Global Technology Operations LLC, Detroit, MI (US)

(72) Inventors: Jacob Alan Bond, Rochester Hills, MI (US); Joseph F. Szczerba, Grand Blanc, MI (US); John P. Weiss, Shelby Township, MI (US); Kai-Han Chang, Sterling Heights, MI (US); Thomas A. Seder, Fraser, MI (US)

(21) Appl. No.: 17/817,043

(22) Filed: Aug. 3, 2022

(51) Int. Cl. G02B 27/01; B60K 35/00; B60W 50/14; G02B 27/00; G06T 7/00

(52) U.S. Cl. CPC G02B 27/0101; B60K 35/00; G02B 27/0179; B60W 50/14; G02B 27/0093; G06T 7/00; B60K 2370/1529; G02B 2027/014; B60K 2370/334; G02B 2027/0138; G02B 2027/0141; G02B 2027/0187; B60W 2050/146; B60K 2370/21; B60K 2370/52

(57) ABSTRACT

A system for displaying information for an occupant of a vehicle includes a plurality of vehicle sensors, a display, and a controller in electrical communication with the plurality of vehicle sensors and the display. The controller is programmed to detect a remote vehicle in an environment surrounding the vehicle using the plurality of vehicle sensors, determine an intended illumination status of at least one indicator of the remote vehicle using the plurality of vehicle sensors, where the intended illumination status includes an intended lit status and an intended un-lit status, and display a graphic based at least in part on the intended illumination status of the at least one indicator of the remote vehicle using the display.

### INTRODUCTION

The present disclosure relates to an augmented reality head-up display for generating a notification to provide information about an acceleration of a remote vehicle which is relevant to the driving task.

Augmented reality (AR) involves enhancing the real world with virtual elements that are shown in three-dimensional space and that permit real-time interaction with users. A head-up display (HUD) shows information such as, for example, vehicle speed and navigational instructions, directly onto a windscreen of a vehicle, within the occupant's forward field of view. Accordingly, the head-up display provides occupants with information without looking away from the road. One possible implementation for augmented reality is an augmented reality head-up display (AR-HUD) for a vehicle. By overlaying images on the windscreen, AR-HUDs enhance an occupant's view of the environment outside the vehicle, creating a greater sense of environmental awareness. Enhanced environmental awareness may be especially important for occupants having a disability such as, for example, color-vision impairment.

Therefore, while current augmented reality head-up displays achieve their intended purpose, there is a need in the art for an improved approach for providing information to vehicle occupants.

### SUMMARY

According to several aspects, a system for displaying information for an occupant of a vehicle is provided. The system includes a plurality of vehicle sensors, a display, and a controller in electrical communication with the plurality of vehicle sensors and the display. The controller is programmed to detect a remote vehicle in an environment surrounding the vehicle using the plurality of vehicle sensors, determine an intended illumination status of at least one indicator of the remote vehicle using the plurality of vehicle sensors, where the intended illumination status includes an intended lit status and an intended un-lit status, and display a graphic based at least in part on the intended illumination status of the at least one indicator of the remote vehicle using the display.

In another aspect of the present disclosure, the plurality of vehicle sensors further may include an external camera. To detect the remote vehicle in the environment surrounding the vehicle, the controller is further programmed to capture an image of the environment surrounding the vehicle using the external camera and identify the remote vehicle by analyzing the image.

In another aspect of the present disclosure, to determine the intended illumination status of the at least one indicator of the remote vehicle, the controller is further programmed to capture an image of the remote vehicle using the external camera, identify an actual illumination status of a brake light of the remote vehicle using the image, where the actual illumination status includes an actual lit status and an actual un-lit status, and determine the intended illumination status of the brake light of the remote vehicle to be the intended lit status in response to the brake light of the remote vehicle having the actual lit status.

In another aspect of the present disclosure, the plurality of vehicle sensors further may include a vehicle communication system. To detect the remote vehicle in the environment surrounding the vehicle, the controller is further programmed to receive a signal from the remote vehicle using the vehicle communication system and detect the remote vehicle based on the signal received from the remote vehicle.

In another aspect of the present disclosure, to determine the intended illumination status of the at least one indicator of the remote vehicle, the controller is further programmed to transmit a message to the remote vehicle using the vehicle communication system, where the message includes a request for the intended illumination status of the at least one indicator of the remote vehicle. To determine the intended illumination status of the at least one indicator of the remote vehicle, the controller is further programmed to receive a response from the remote vehicle using the vehicle communication system, where the response includes the intended illumination status of the at least one indicator of the remote vehicle.

In another aspect of the present disclosure, the plurality of vehicle sensors further may include an electronic ranging sensor. To detect the remote vehicle in the environment surrounding the vehicle, the controller is further programmed to measure a first object distance between the vehicle and an object in the environment surrounding the vehicle using the electronic ranging sensor. To detect the remote vehicle in the environment surrounding the vehicle, the controller is further programmed to detect the remote vehicle based at least in part on the first object distance between the vehicle and the object in the environment surrounding the vehicle.

In another aspect of the present disclosure, to determine the intended illumination status of the at least one indicator of the remote vehicle, the controller is further programmed to measure a first remote vehicle velocity using the electronic ranging sensor, wait for a predetermined delay time period, and measure a second remote vehicle velocity using the electronic ranging sensor. To determine the intended illumination status of the at least one indicator of the remote vehicle, the controller is further programmed to determine the acceleration of the remote vehicle based at least in part on the first remote vehicle velocity, the second remote vehicle velocity and the predetermined delay time period. To determine the intended illumination status of the at least one indicator of the remote vehicle, the controller is further programmed to determine the intended illumination status of the at least one indicator of the remote vehicle based on the acceleration of the remote vehicle.

In another aspect of the present disclosure, to determine the intended illumination status of the at least one indicator of the remote vehicle based on the acceleration of the remote vehicle, the controller is further programmed to compare the acceleration of the remote vehicle to a predetermined acceleration threshold, where the predetermined acceleration threshold is less than zero. To determine the intended illumination status of the at least one indicator of the remote vehicle based on the acceleration of the remote vehicle, the controller is further programmed to determine the intended illumination status of the at least one indicator of the remote vehicle to be the intended lit status in response to determining that the acceleration of the remote vehicle is less than or equal to the predetermined acceleration threshold.

In another aspect of the present disclosure, the display is an augmented reality head-up display (AR-HUD) system in electronic communication with the controller, where the AR-HUD system includes an occupant position tracking device and an AR-HUD projector. To display the graphic the controller is further programmed to determine a position of an occupant of the vehicle using the occupant position tracking device and calculate a size, shape, and location of the graphic based on the position of the occupant and data from at least one of the plurality of vehicle sensors. To display the graphic the controller is further programmed to display the graphic corresponding to the intended illumination status of the at least one indicator of the remote vehicle on a windscreen of the vehicle using the AR-HUD system based on the size, shape, and location of the graphic.

In another aspect of the present disclosure, the display further includes a transparent windscreen display (TWD) system in electronic communication with the controller, where the TWD system includes transparent phosphors embedded in the windscreen of the vehicle and a TWD projector. To display the graphic the controller is further programmed to calculate a size, shape, and location of the graphic based on data from at least one of the plurality of vehicle sensors. To display the graphic the controller is further programmed to display the graphic corresponding to the intended illumination status of the at least one indicator of the remote vehicle on the windscreen of the vehicle using the TWD system based on the size, shape, and location of the graphic.

According to several aspects, a method for displaying information upon a windscreen of a vehicle is provided. The method includes detecting a remote vehicle in an environment surrounding the vehicle using at least one of a plurality of vehicle sensors, determining an acceleration of the remote vehicle using at least one of the plurality of vehicle sensors, and displaying a graphic on the windscreen, where the graphic displayed is based at least in part on the acceleration of the remote vehicle.

In another aspect of the present disclosure, detecting the remote vehicle further may include capturing an image of the environment surrounding the vehicle using an external camera and identifying the remote vehicle by analyzing the image.

In another aspect of the present disclosure, determining the acceleration of the remote vehicle further may include capturing an image of the remote vehicle using the external camera, identifying an illumination status of a brake light of the remote vehicle using the image, where the illumination status includes an illuminated status and a non-illuminated status, and determining the acceleration of the remote vehicle to be negative in response to the brake light of the remote vehicle having an illuminated status.

In another aspect of the present disclosure, detecting the remote vehicle further may include receiving a signal from the remote vehicle using a vehicle communication system and detecting the remote vehicle based on the signal received from the remote vehicle.

In another aspect of the present disclosure, determining the acceleration of the remote vehicle further may include transmitting a message to the remote vehicle using the vehicle communication system, where the message includes a request for acceleration data of the remote vehicle. Determining the acceleration of the remote vehicle further may include receiving a response from the remote vehicle using the vehicle communication system, where the response includes the acceleration of the remote vehicle.

In another aspect of the present disclosure, detecting the remote vehicle further may include measuring a first object distance between the vehicle and an object in the environment surrounding the vehicle using an electronic ranging sensor and detecting the remote vehicle based at least in part on the first object distance between the front of the vehicle and the object in the environment surrounding the vehicle.

In another aspect of the present disclosure, determining the acceleration of the remote vehicle further may include measuring a first remote vehicle velocity using the electronic ranging sensor, waiting for a predetermined delay time period, and measuring a second remote vehicle velocity using the electronic ranging sensor. Determining the acceleration of the remote vehicle further may include determining the acceleration of the remote vehicle based at least in part on the first remote vehicle velocity, the second remote vehicle velocity and the predetermined delay time period.

In another aspect of the present disclosure, displaying the graphic further may include calculating a size, shape, and location of the graphic based on data from at least one of an exterior camera and an occupant position tracking device. Displaying the graphic further may include displaying the graphic corresponding to the acceleration of the remote vehicle on the windscreen of the vehicle using at least one of a transparent windscreen display (TWD) system and an augmented reality head-up display (AR-HUD) system based on the size, shape, and location of the graphic.

According to several aspects, a system for displaying information for a vehicle is provided. The system includes a plurality of vehicle sensors including an exterior camera, an electronic ranging sensor, and a vehicle communication system. The system also includes a display system including an augmented reality head-up display (AR-HUD) system and a transparent windscreen display (TWD) system. The system also includes a controller in electrical communication with the plurality of vehicle sensors and the display system, The controller is programmed to detect a remote vehicle in an environment surrounding the vehicle using at least one of the plurality of vehicle sensors, determine an acceleration of the remote vehicle using at least one of the plurality of vehicle sensors, and compare the acceleration of the remote vehicle to a predetermined acceleration threshold, where the predetermined acceleration threshold is less than zero. The controller is further programmed to display a graphic on a windscreen of the vehicle in response to determining that the acceleration of the remote vehicle is less than or equal to the predetermined acceleration threshold, where the graphic appears to be overlayed on the remote vehicle from a viewing perspective of an occupant of the vehicle, and where the graphic indicates that the remote vehicle is decelerating.

In another aspect of the present disclosure, to determine the acceleration of the remote vehicle, the controller is further programmed to attempt to establish a wireless vehicle-to-vehicle (V2V) connection to the remote vehicle and determine a connection status of the attempt to establish the wireless V2V connection, wherein the connection status includes a successful connection status and an unsuccessful connection status. To determine the acceleration of the remote vehicle, the controller is further programmed to transmit a message to the remote vehicle using the vehicle communication system in response to determining that the connection status is the successful connection status, wherein the message includes a request for acceleration data of the remote vehicle. To determine the acceleration of the remote vehicle, the controller is further programmed to receive the acceleration of the remote vehicle using the vehicle communication system after transmitting the message to the remote vehicle. To determine the acceleration of the remote vehicle, the controller is further programmed to measure a first remote vehicle velocity using the electronic ranging sensor in response to determining that the connection status is the unsuccessful connection status and wait for a predetermined delay time period after measuring the first remote vehicle velocity. To determine the acceleration of the remote vehicle, the controller is further programmed to measure a second remote vehicle velocity using the electronic ranging sensor after waiting for the predetermined delay time period and determine the acceleration of the remote vehicle based at least in part on the first remote vehicle velocity, the second remote vehicle velocity and the predetermined delay time period.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a system for displaying information about an acceleration of a remote vehicle according to an exemplary embodiment;

FIG. 2 is a schematic diagram of an AR-HUD system for use by an exemplary occupant according to an exemplary embodiment;

FIG. 3 is a schematic front view of a dual-focal plane augmented reality display, highlighting a second image plane of the dual-focal plane augmented reality display according to an exemplary embodiment;

FIG. 4 is a schematic diagram of the second image plane of the dual-focal plane augmented according to an exemplary embodiment;

FIG. 5 is a flowchart of a method for displaying information about an acceleration of a remote vehicle upon a windscreen of a vehicle according to an exemplary embodiment;

FIG. 6A is a flowchart of a first method for determining an acceleration of a remote vehicle according to an exemplary embodiment;

FIG. 6B is a flowchart of a second method for determining an acceleration of a remote vehicle according to an exemplary embodiment;

FIG. 6C is a flowchart of a third method for determining an acceleration of a remote vehicle according to an exemplary embodiment;

FIG. 7A is a diagram of a first exemplary graphic overlayed on an exemplary remote vehicle;

FIG. 7B is a diagram of a second exemplary graphic overlayed on an exemplary remote vehicle;

FIG. 7C is a diagram of a third exemplary graphic overlayed on an exemplary remote vehicle;

FIG. 7D is a diagram of a fourth exemplary graphic overlayed on an exemplary remote vehicle;

FIG. 7E is a diagram of a fifth exemplary graphic overlayed on an exemplary remote vehicle;

FIG. 7F is a diagram of a sixth exemplary graphic overlayed on an exemplary remote vehicle;

### DETAILED DESCRIPTION

The following description is merely exemplary in nature and is not intended to limit the present disclosure, application, or uses.

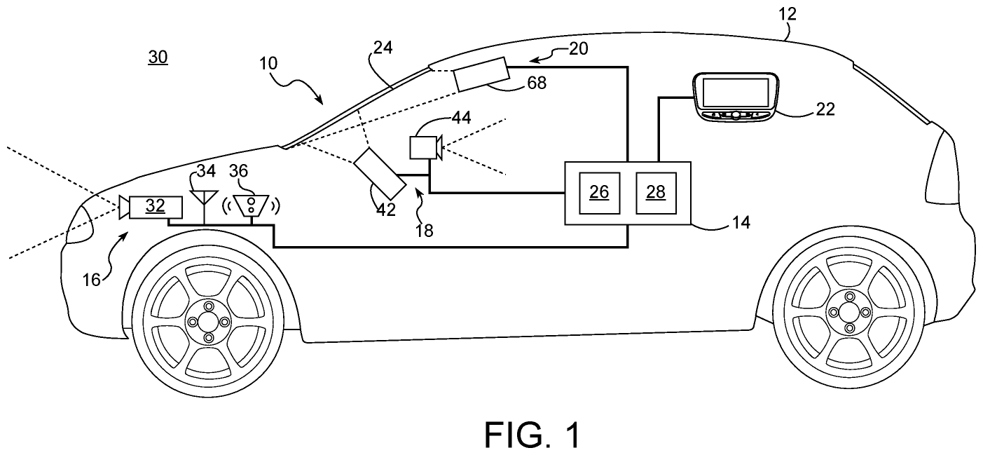

Referring to FIG. 1, a system for displaying information about an acceleration of a remote vehicle is illustrated and generally indicated by reference number 10. The system 10 is shown with an exemplary vehicle 12. While a passenger vehicle is illustrated, it should be appreciated that the vehicle 12 may be any type of vehicle without departing from the scope of the present disclosure. The system 10 generally includes a controller 14, vehicle sensors 16, an augmented reality head-up display (AR-HUD) system 18, a transparent windscreen display (TWD) system 20, and a human-machine interface (HMI) 22.

The controller 14 is used to implement a method 100 for displaying information about an acceleration of a remote vehicle upon a windscreen 24 of the vehicle 12, as will be described below. The controller 14 includes at least one processor 26 and a non-transitory computer readable storage device or media 28. The processor 26 may be a custom made or commercially available processor, a central processing unit (CPU), a graphics processing unit (GPU), an auxiliary processor among several processors associated with the controller 14, a semiconductor-based microprocessor (in the form of a microchip or chip set), a macroprocessor, a combination thereof, or generally a device for executing instructions. The computer readable storage device or media 28 may include volatile and nonvolatile storage in read-only memory (ROM), random-access memory (RAM), and keep-alive memory (KAM), for example. KAM is a persistent or non-volatile memory that may be used to store various operating variables while the processor 26 is powered down. The computer-readable storage device or media 28 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 14 to control various systems of the vehicle 12. The controller 14 may also consist of multiple controllers which are in electrical communication with each other.

The controller 14 is in electrical communication with the vehicle sensors 16, the AR-HUD system 18, the TWD system 20, and the HMI 22. The electrical communication may be established using, for example, a CAN bus, a Wi-Fi network, a cellular data network, or the like. It should be understood that various additional wired and wireless techniques and communication protocols for communicating with the controller 14 are within the scope of the present disclosure.

The vehicle sensors 16 are used to acquire information about an environment 30 surrounding the vehicle 12. In an exemplary embodiment, the vehicle sensors 16 include an exterior camera 32, a vehicle communication system 34, and an electronic ranging sensor 36. It should be understood that the vehicle sensors 16 may include additional sensors for determining characteristics of the vehicle 12, for example, vehicle speed, roadway curvature, and/or vehicle steering without departing from the scope of the present disclosure. The vehicle sensors 16 are in electrical communication with the controller 14 as discussed above.

The exterior camera 32 is used to capture images and/or videos of the environment 30 surrounding the vehicle 12. In an exemplary embodiment, the exterior camera 32 is a photo and/or video camera which is positioned to view the environment 30 in front of the vehicle 12. In one example, the exterior camera 32 is affixed inside of the vehicle 12, for example, in a headliner of the vehicle 12, having a view through the windscreen 24. In another example, the exterior camera 32 is affixed outside of the vehicle 12, for example, on a roof of the vehicle 12, having a view of the environment 30 in front of the vehicle 12. It should be understood that cameras having various sensor types including, for example, charge-coupled device (CCD) sensors, complementary metal oxide semiconductor (CMOS) sensors, and/or high dynamic range (HDR) sensors are within the scope of the present disclosure. Furthermore, cameras having various lens types including, for example, wide-angle lenses and/or narrow-angle lenses are also within the scope of the present disclosure.

The vehicle communication system 34 is used by the controller 14 to communicate with other systems external to the vehicle 12. For example, the vehicle communication system 34 includes capabilities for communication with vehicles (“V2V” communication), infrastructure (“V2I” communication), remote systems at a remote call center (e.g., ON-STAR by GENERAL MOTORS) and/or personal devices. In certain embodiments, the vehicle communication system 34 is a wireless communication system configured to communicate via a wireless local area network (WLAN) using IEEE 802.11 standards or by using cellular data communication. However, additional, or alternate communication methods, such as a dedicated short-range communications (DSRC) channel and/or mobile telecommunications protocols based on the 3^{rd} Generation Partnership Project (3GPP) standards, are also considered within the scope of the present disclosure. DSRC channels refer to one-way or two-way short-range to medium-range wireless communication channels specifically designed for automotive use and a corresponding set of protocols and standards. The 3GPP refers to a partnership between several standards organizations which develop protocols and standards for mobile telecommunications. 3GPP standards are structured as “releases”. Thus, communication methods based on 3GPP release 14, 15, 16 and/or future 3GPP releases are considered within the scope of the present disclosure. Accordingly, the vehicle communication system 34 may include one or more antennas and/or communication transceivers for receiving and/or transmitting signals, such as cooperative sensing messages (CSMs). The vehicle communication system 34 is configured to wirelessly communicate information between the vehicle 12 and another vehicle. Further, the vehicle communication system 34 is configured to wirelessly communicate information between the vehicle 12 and infrastructure or other vehicles.

The electronic ranging sensor 36 is used to determine a range (i.e., distance) between the vehicle 12 and objects in the environment 30 surrounding the vehicle. The electronic ranging sensor 36 may utilize electromagnetic waves (e.g., radar), sound waves (e.g., ultrasound), and/or light (e.g., lidar) to determine the range. In the exemplary embodiment shown in FIG. 1, the electronic ranging sensor 36 is a lidar sensor. It should be understood that embodiments wherein the electronic ranging sensor 36 includes a radar sensor, ultrasound sensor, lidar sensor, and/or additional sensors configured to determine a range (i.e., distance) are within the scope of the present disclosure.

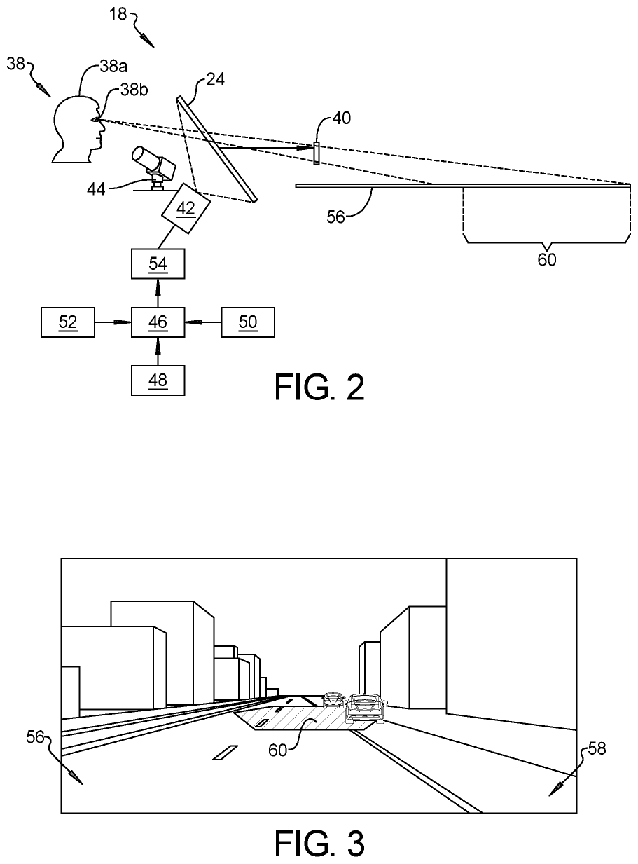

Referring to FIG. 2, a system diagram of the AR-HUD system 18 for use by an exemplary occupant 38 is shown. In the scope of the present disclosure, the occupant includes, in a non-limiting example, a driver, a passenger, and/or any additional persons in the vehicle 12. The AR-HUD system 18 is used to display AR-HUD graphics 40 (i.e., notification symbols providing visual information to the occupant 38) on the windscreen 24 of the vehicle 12. The AR-HUD system 18 includes an AR-HUD projector 42 and an occupant position tracking device 44. The AR-HUD system 18 is in electrical communication with the controller 14 as discussed above.

The AR-HUD projector 42 is used to project the AR-HUD graphics 40 on the windscreen 24 of the vehicle 12. It should be understood that various devices designed to project images including, for example, optical collimators, laser projectors, digital light projectors (DLP), and the like are within the scope of the present disclosure.

The occupant position tracking device 44 is used to determine a position of the occupant 38 in the vehicle 12. For example, the occupant position tracking device 44 may track a position of a head 38a or eyes 38b of the occupant 38. The position of the occupant 38 in the vehicle 12 from the occupant position tracking device 44 is used to locate the AR-HUD graphic 40 on a windscreen 24 of the vehicle 12. In an exemplary embodiment, the occupant position tracking device 44 is one or more cameras disposed in the vehicle 12.

To operate the AR-HUD system 18, the controller 14 includes multiple software modules, including a system manager 46. During operation of the system 10, the system manager 46 receives at least a first input 48, a second input 50, and a third input 52. The first input 48 is indicative of the location of the vehicle 12 in space (i.e., the geographical location of the vehicle 12), the second input 50 is indicative of the vehicle occupant 38 position in the vehicle 12 (e.g., the position of the eyes and/or head of the occupant 38 in the vehicle 12), and the third input 52 is data pertaining to an intended illumination status of at least one indicator of the remote vehicle, as will be discussed in greater detail below. The first input 48 may include data such as GNSS data (e.g., GPS data), vehicle speed, roadway curvature, and vehicle steering, and this data is collected from the vehicle sensors 16. The second input 50 is received from the occupant position tracking device 44. The third input 52 is data pertaining to the acceleration of the remote vehicle in the environment 30 surrounding the vehicle 12. The system manager 46 is configured to determine (e.g., compute) the type, size, shape, and color of the AR-HUD graphics 40 to be displayed using the AR-HUD projector 42 based on the first input 48 (i.e., the vehicle location in the environment 30), the second input 50 (e.g., the position of the eyes 38b and/or head 38a of the occupant 38 in the vehicle 12), and the third input 52 (i.e. the intended illumination status of the at least one indicator of the remote vehicle in the environment 30 surrounding the vehicle 12) The system manager 46 instructs an image engine 54, which is a software module or an integrated circuit of the AR-HUD projector 42 or the controller 14, to display the AR-HUD graphic 40 using the AR-HUD projector 42. The image engine 54 displays the AR-HUD graphic 40 on the windscreen 24 of the vehicle 12 using the AR-HUD projector 42 based on the type, size, shape, and color of the AR-HUD graphic 40 determined by the system manager 46. The AR-HUD graphic 40 is projected on the windscreen 24 by the AR-HUD projector 42 to show the AR-HUD graphic 40 along a roadway surface 56.

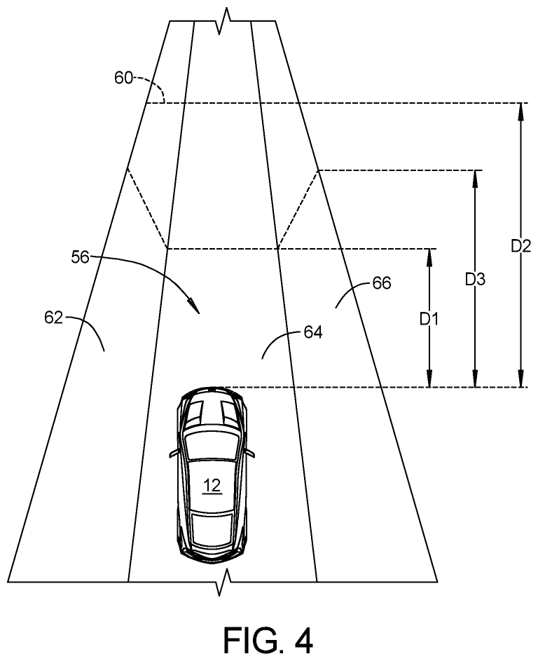

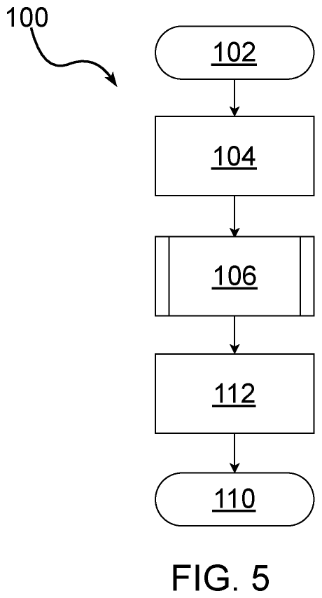

In the exemplary embodiment of the present disclosure, the AR-HUD system 18 is a dual-focal plane AR-HUD system. With reference to FIGS. 3 and 4 and with continued reference to FIG. 2, the AR-HUD system 18 has a first image plane 58 and a second image plane 60. The first image plane 58 shows the view of the outside world, and the second image plane 60 is reserved for displaying the AR-HUD graphics 40. The second image plane 60 spans multiple lanes and the AR-HUD graphics 40 appear at a location farther on a roadway surface 56 relative to the first image plane 58. For instance, as shown in FIGS. 3 and 4, the second image plane 60 covers a left lane 62, a central lane 64, and a right lane 66. As a non-limiting example, in the central lane 64, the second image plane 60 starts at a first predetermined distance D1 (e.g., twenty-five meters) from the vehicle 12 and ends at a second predetermined distance D2 (e.g., ninety meters) from the vehicle 12. Regardless of the specific distances, the second predetermined distance D2 is greater than the first predetermined distance D1 to help the occupant 38 see the AR-HUD graphics 40 displayed using the AR-HUD projector 42. In the left lane 62 and the right lane 66, the second image plane 60 is delimited by a sloped boundary that starts at the first predetermined distance D1 from the vehicle 12 and ends at a third predetermined distance D3 (e.g., fifty meters) from the vehicle 12. The third predetermined distance D3 is greater than the first predetermined distance D1 and less than the second predetermined distance D2 to help the occupant 38 see the AR-HUD graphics 40 displayed using the AR-HUD projector 42. As used herein, the term “dual-focal plane AR-HUD” means an AR-HUD system that presents images in a first image plane and a second image plane, wherein the first image plane and the second image plane are at different locations. It is desirable to configure the AR-HUD system 18 as a dual-focal plane AR-HUD to facilitate manipulation of the AR-HUD graphics 40 on the view of the outside word. For instance, by using a dual-focal plane AR-HUD, the size, location, and characteristics of the AR-HUD graphics 40 may be changed based on, for example, the location of the eyes 38b of the occupant 38.

The TWD system 20 is used to display images on the windscreen 24 of the vehicle 12. In an exemplary embodiment, the AR-HUD system 18 can display the AR-HUD graphics 40 in a predefined region of the windscreen 24 (e.g., in the first image plane 58 and the second image plane 60). The TWD system 20 can display TWD graphics (not shown) in any region of the windscreen 24. Therefore, by operating the AR-HUD system 18 and the TWD system 20 in conjunction, the controller 14 may display graphics in any region of the windscreen 24. In an exemplary embodiment, the TWD system 20 includes transparent phosphors (not shown) embedded into the windscreen 24 and a TWD projector 68 (FIG. 1). The TWD system 20 is in electrical communication with the controller 14 as discussed above.

The transparent phosphors are light emitting particles which fluoresce in response to being excited by the TWD projector 68. In an exemplary embodiment, the transparent phosphors are red, green, and blue (RGB) phosphors, allowing full color operation of the TWD system 20. The use of monochrome and/or two-color phosphors is also within the scope of the present disclosure. When excitation light is absorbed by the transparent phosphors, visible light is emitted by the transparent phosphors. The excitation light may be, for example, violet light in the visible spectrum (ranging from about 380 to 450 nanometers) and/or ultraviolet light.

The TWD projector 68 is used to excite the transparent phosphors in a predetermined pattern to produce the TWD graphics on the windscreen 24. In an exemplary embodiment, the TWD projector 68 is a violet/ultraviolet laser projector disposed proximally to the headliner of the vehicle 12. The TWD projector 68 includes three lasers, each laser configured to excite one of the red, green, or blue transparent phosphors.

In an exemplary embodiment, the HMI 22 is used in addition to the AR-HUD system 18 and the TWD system 20 to display information about the acceleration of the remote vehicle. In another exemplary embodiment, the HMI 22 is used instead of the AR-HUD system 18 and/or the TWD system 20 to display information about the acceleration of the remote vehicle. In the aforementioned exemplary embodiments, the HMI 22 is a display system located in view of the occupant 38 and capable of displaying text, graphics, and/or images. It is to be understood that HMI display systems including LCD displays, LED displays, and the like are within the scope of the present disclosure. Further exemplary embodiments where the HMI 22 is disposed in a rearview mirror are also within the scope of the present disclosure. The HMI 22 is in electrical communication with the controller 14 as discussed above.

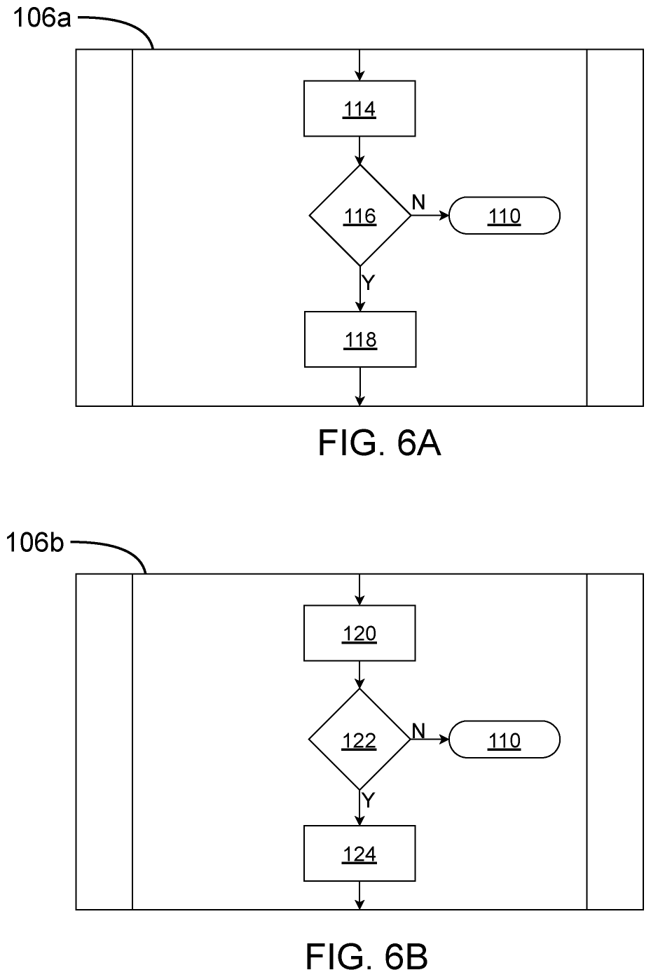

Referring to FIG. 5, a flowchart of the method 100 for displaying information about the acceleration of the remote vehicle upon a windscreen 24 of the vehicle 12 is shown according to an exemplary embodiment. The method 100 begins at block 102 and proceeds to block 104. At block 104, the vehicle sensors 16 are used to identify the remote vehicle in the environment 30. In the present disclosure, the term remote vehicle refers to a vehicle which is relevant to the driving task (e.g., a remote vehicle located on a road upon which the vehicle 12 is driving, directly ahead of the vehicle 12). In an exemplary embodiment, the exterior camera 32 captures an image of the environment 30, and the controller 14 analyzes the image of the environment to identify the remote vehicle. In a non-limiting example, the controller 14 analyzes the image using a machine learning algorithm (e.g., a neural network). The machine learning algorithm is trained by providing the algorithm with a plurality of image samples of remote vehicles which have been pre-identified. For example, the plurality of image samples may include images of various types of vehicles in various environmental conditions and with varying relevance to the driving task. After sufficient training of the machine learning algorithm, the algorithm can identify remote vehicles in an image captured with the exterior camera 32 with a high accuracy and precision. In another exemplary embodiment, the vehicle communication system 34 is used to receive transmissions from a remote vehicle identifying a location of the remote vehicle. The location received from the remote vehicle is compared to a location of the vehicle 12 as determined by a global navigation satellite system (GNSS) of the vehicle 12. Based on the comparison between the location of the remote vehicle and the location of the vehicle 12, the remote vehicle may be identified as relevant to the driving task. In a non-limiting example, if the distance between the remote vehicle and the vehicle 12 is below a predetermined threshold, and the vehicle 12 is oriented such that the remote vehicle is within a field-of-view of the occupant 38, the remote vehicle is identified as relevant to the driving task. In yet another exemplary embodiment, the electronic ranging sensor 36 is used to identify the remote vehicle based on a plurality of distance measurements. For example, the controller 14 may use the plurality of distance measurements as an input to a machine learning algorithm to identify the remote vehicle. It is to be understood that the three aforementioned exemplary embodiments may be performed mutually exclusively, sequentially, and/or simultaneously within the scope of the present disclosure. After block 104, the method 100 proceeds to block 106.

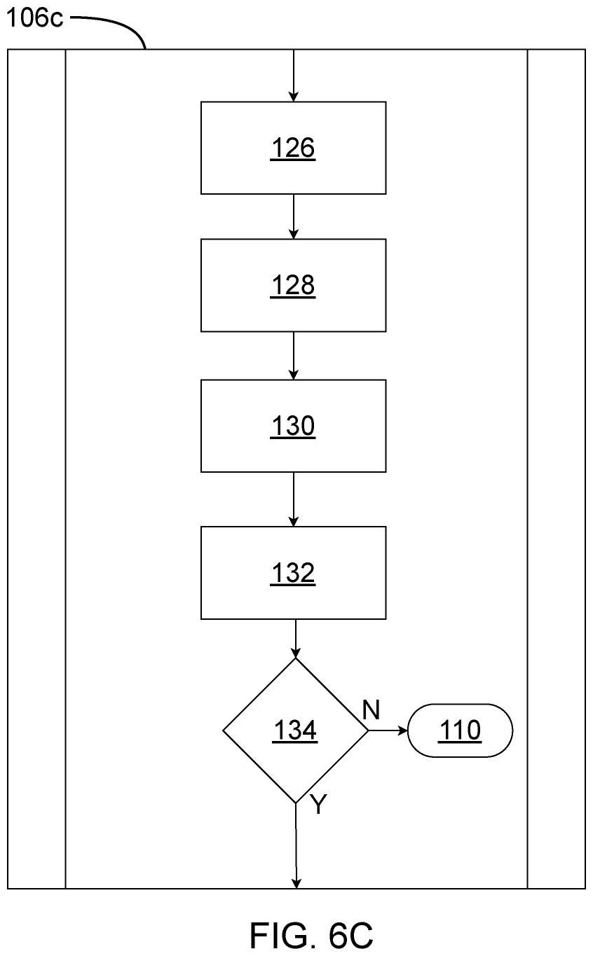

At block 106, the controller 14 uses the vehicle sensors 16 to determine the intended illumination status of at least one indicator of the remote vehicle identified at block 104. In the scope of the present disclosure, the at least one indicator includes, for example, a brake light, a turn signal light, a reverse light, a parking light, a daytime running light, and/or a headlight of the remote vehicle. In the scope of the present disclosure, the intended illumination status indicates the illumination status which accurately indicates the actions and/or intentions of a driver of the remote vehicle to other drivers. For example, if the remote vehicle is determined to have a negative acceleration less than a predetermined acceleration threshold (as will be discussed in greater detail below), the intended illumination status of the brake lights of the remote vehicle is the lit status. In another example, if the remote vehicle is determined to have a negative velocity (i.e., the remote vehicle is reversing), the intended illumination status of at least one reverse light of the vehicle is the lit status. In the following exemplary embodiments, the at least one indicator is the brake lights of the remote vehicle. It should be understood that additional embodiments may use analogous methods to determine the intended illumination status of additional indicators (i.e., the indicators discussed above) without departing from the scope of the present disclosure. The present disclosure contemplates at least three exemplary embodiments of block 106. The exemplary embodiments of block 106 will be discussed in detail below in reference to FIGS. 6A, 6B, and 6C. After block 106, the method 100 proceeds to block 112.

At block 112, the AR-HUD system 18, the TWD system 20, and/or the HMI 22 display a graphic indicating the intended illumination status of the at least one indicator of the remote vehicle, for example, the brake lights of the remote vehicle. As discussed above in reference to FIG. 2, the AR-HUD system 18 calculates a size, shape, and location of the graphic based on data from the vehicle sensors 16 and the occupant position tracking device 44. In an exemplary embodiment, the AR-HUD system 18 is used when the remote vehicle is within the first image plane 58 and/or the second image plane 60. If the remote vehicle is outside of the first image plane 58 and the second image plane 60, the TWD system 20 is used to display the graphic. In an exemplary embodiment where the AR-HUD system 18 and the TWD system 20 are not available (e.g., not equipped on the vehicle 12 or non-functional) the HMI 22 is used to display the graphic. In an exemplary embodiment, characteristics of the graphic including luminance, saturation, and/or contrast may be adjusted to increase the saliency of the graphic for the occupant 38. In another exemplary embodiment, the graphic includes animations (i.e., motion of the graphic) to draw the attention of the occupant 38 to the graphic. After block 112, the method 100 proceeds to enter a standby state at block 110.

In an exemplary embodiment, the controller 14 may repeatedly exit the standby state 110 and restart the method 100 at block 102. By repeatedly performing the method 100, the displayed graphics are updated to account for motion of the vehicle 12 and changing acceleration of the remote vehicle.

Referring to FIG. 6A, a first exemplary embodiment of the block 106 discussed above is referred to by reference numeral 106a. The first exemplary embodiment 106a determines the intended illumination status of the brake lights of the remote vehicle using the exterior camera 32. The first exemplary embodiment 106a begins after block 104 of the method 100 at block 114. At block 114, the controller 14 uses the exterior camera 32 to capture an image of the remote vehicle. After block 114, the first exemplary embodiment 106a proceeds to block 116.

At block 116, the image captured at block 114 is analyzed by the controller 14 to determine whether at least one brake light of the remote vehicle is illuminated (i.e., identify an actual illumination status of the brake lights of the remote vehicle). In a non-limiting example, the controller 14 analyzes the image using a machine learning algorithm (e.g., a neural network). The machine learning algorithm is trained by providing the algorithm with a plurality of image samples of remote vehicles with brake lights which have been pre-identified as illuminated or non-illuminated. For example, the plurality of image samples may include images of various types of vehicles in various environmental conditions and with varying configurations of brake lights. After sufficient training of the machine learning algorithm, the algorithm whether at least one brake light of the remote vehicle in an image captured with the exterior camera 32 is illuminated with a high accuracy and precision. If no brake lights of the remote are determined to be illuminated, the first exemplary embodiment 106a proceeds to enter the standby state at block 110. If at least one brake light of the remote vehicle is determined to be illuminated, the first exemplary embodiment 106a proceeds to block 118.

At block 118, the intended illumination status of the brake lights of the remote vehicle is determined to be the intended lit status, because at least one brake light of the remote vehicle was determined to be illuminated at block 116. After block 118, the method 100 continues to block 112 as described above.

Referring to FIG. 6B, a second exemplary embodiment of the block 106 discussed above is referred to by reference numeral 106b. The second exemplary embodiment 106b determines the intended illumination status of the brake lights of the remote vehicle using the vehicle communication system 34. The second exemplary embodiment 106b begins after block 104 of the method 100 at block 120. At block 120, the controller 14 uses the vehicle communication system 34 to transmit a message (e.g., a vehicle-to-vehicle message, as discussed above) to the remote vehicle requesting acceleration data from the remote vehicle. After block 120, the second exemplary embodiment 106b proceeds to block 122.

At block 122, the controller 14 monitors the vehicle communication system 34 for a response to the message transmitted at block 120. If a response containing the intended illumination status of the brake lights of the remote vehicle is not received after a predetermined delay period, the second exemplary embodiment 106b proceeds to enter the standby state at block 110. If a response containing the intended illumination status of the brake lights of the remote vehicle is received, the second exemplary embodiment 106b proceeds to block 124.

At block 124 the intended illumination status of the brake lights of the remote vehicle is determined based on the response received at block 122. After block 124, the method 100 continues to block 112 as described above.

Referring to FIG. 6C, a third exemplary embodiment of the block 106 discussed above is referred to by reference numeral 106c. The third exemplary embodiment 106c determines the acceleration of the remote vehicle using the electronic ranging sensor 36. The third exemplary embodiment 106c begins after block 104 of the method 100 at block 126. At block 126, the controller 14 uses the electronic ranging sensor 36 measure a first velocity of the remote vehicle. In a non-limiting example, to measure the first velocity of the remote vehicle, the controller 14 uses the electronic ranging sensor 36 to record a plurality of distance measurements between the vehicle 12 and the remote vehicle. Based on a comparison between each of the plurality of distance measurements and a comparison between a time at which each of the plurality of distance measurements was recorded, the first velocity of the remote vehicle relative to the vehicle 12 is determined. After block 126, the third exemplary embodiment 106c proceeds to block 128.

At block 128, the controller 14 waits a predetermined delay period (e.g., 500 milliseconds). After block 128, the third exemplary embodiment 106c proceeds to block 130.

At block 130, the controller 14 uses the electronic ranging sensor 36 measure a second velocity of the remote vehicle. In a non-limiting example, the second velocity is measured in the same manner as discussed above in reference to the first velocity. After block 130, the third exemplary embodiment 106c proceeds to block 132.

At block 132, the acceleration of the remote vehicle is determined based on the first velocity of the remote vehicle measured at block 126, the second velocity of the remote vehicle measured at block 130, and the predetermined delay time period. After block 132, the third exemplary embodiment 106c proceeds to block 134.

At block 134, the controller 14 compares the acceleration of the remote vehicle determined at block 132 to a predetermined acceleration threshold (e.g., −2 mph/sec). If the acceleration of the remote vehicle is greater than the predetermined acceleration threshold, the third exemplary embodiment 106c proceeds to enter a standby mode at block 110. If the acceleration of the remote vehicle is less than or equal to the predetermined acceleration threshold, the intended illumination status of at least one brake light of the vehicle 12 is determined to be the intended lit status. After block 134, the method 100 proceeds to block 112 as described above.

It is to be understood that the first exemplary embodiment 106a, second exemplary embodiment 106b, and/or third exemplary embodiment 106c may be performed mutually exclusively, sequentially, and/or simultaneously within the scope of the present disclosure. In a non-limiting example, the controller 14 first attempts to perform the second exemplary embodiment 106b. If the controller 14 is unable to establish a V2V connection to the remote vehicle, the controller 14 then proceeds to the first exemplary embodiment 106a and/or the third exemplary embodiment 106c.

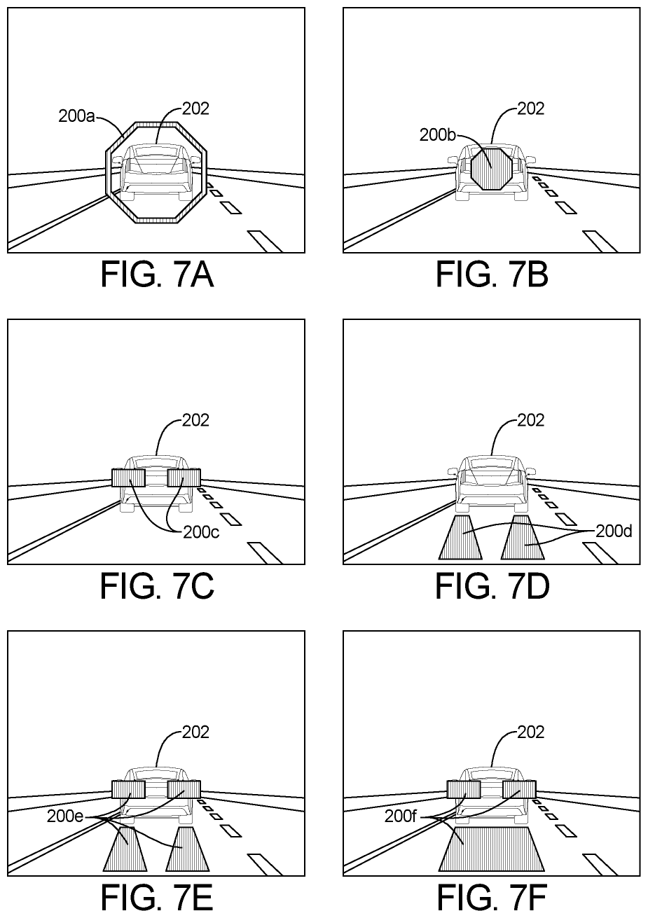

Referring to FIG. 7A, a first exemplary graphic 200a is shown overlayed on an exemplary remote vehicle 202. The first exemplary graphic 200a includes an octagonal portion overlayed on the exemplary remote vehicle 202 to indicate to the occupant 38 that the exemplary remote vehicle 202 is slowing down (i.e., has an acceleration less than or equal to the predetermined acceleration threshold, as discussed above).

Referring to FIG. 7B, a second exemplary graphic 200b is shown overlayed on the exemplary remote vehicle 202. The second exemplary graphic 200b includes an octagonal portion overlayed on the exemplary remote vehicle 202 to indicate to the occupant 38 that the exemplary remote vehicle 202 is slowing down (i.e., has an acceleration less than or equal to the predetermined acceleration threshold). In a non-limiting example, the octagonal shape of the exemplary graphics 200a, 200b is chosen to indicate to a color-vision impaired driver that the exemplary remote vehicle 202 is slowing down.

Referring to FIG. 7C, a third exemplary graphic 200c is shown overlayed on the exemplary remote vehicle 202. The third exemplary graphic 200c includes two rectangular portions, each overlayed on a brake light of the exemplary remote vehicle 202 to indicate to the occupant 38 that the exemplary remote vehicle 202 is slowing down (i.e., has an acceleration less than or equal to the predetermined acceleration threshold).

Referring to FIG. 7D, a fourth exemplary graphic 200d is shown overlayed on the exemplary remote vehicle 202. The fourth exemplary graphic 200d includes two polygons overlayed on a road surface behind the exemplary remote vehicle 202 to indicate to the occupant 38 that the exemplary remote vehicle 202 is slowing down (i.e., has an acceleration less than or equal to the predetermined acceleration threshold).

Referring to FIG. 7E, a fifth exemplary graphic 200e is shown overlayed on the exemplary remote vehicle 202. The fifth exemplary graphic 200e is a combination of the third exemplary graphic 202c and the fourth exemplary graphic 202d. Thus, the fifth exemplary graphic 200e indicates to the occupant 38 that the exemplary remote vehicle 202 is slowing down (i.e., has an acceleration less than or equal to the predetermined acceleration threshold) as discussed above.

Referring to FIG. 7F, a sixth exemplary graphic 200f is shown overlayed on an exemplary remote vehicle 202. The sixth exemplary graphic 200f is a modified version of the fifth exemplary graphic including a larger rectangular portion overlayed on the road surface behind the remote vehicle. Thus, the sixth exemplary graphic 200f indicates to the occupant 38 that the exemplary remote vehicle 202 is slowing down (i.e., has an acceleration less than or equal to the predetermined acceleration threshold) as discussed above.

The system 10 and method 100 of the present disclosure offer several advantages. Color-vision impaired drivers may have difficulty distinguishing indicators (e.g., brake lights) of vehicles on the roadway, creating a safety concern. The system 10 and method 100 may be used to increase the awareness of a color-vision impaired driver to indicators of vehicles on the roadway. Additionally, conditions like bright sunlight, inclement weather, and/or obstructed indicators may cause drivers difficulty in distinguishing the actual illumination status of indicators. Furthermore, electrical and/or mechanical failures of vehicles may cause indicators to fail to illuminate, even when, for example, the vehicle is slowing down. The system 10 and method 100 may be used to improve driver awareness in the aforementioned situations. In some exemplary embodiments, in the case that at least one brake light of a remote vehicle fails to illuminate when the remote vehicle is slowing down, the vehicle 12 may take action to inform the remote vehicle of the brake light failure. In a non-limiting example, the vehicle communication system 34 is used to send a message to the remote vehicle containing information about the brake light failure.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A system for displaying information for an occupant of a vehicle, the system comprising:
a plurality of vehicle sensors;
a display; and
a controller in electrical communication with the plurality of vehicle sensors and the display, wherein the controller is programmed to:
detect a remote vehicle in an environment surrounding the vehicle using the plurality of vehicle sensors;
determine an intended illumination status of at least one indicator of the remote vehicle using the plurality of vehicle sensors, wherein the intended illumination status includes an intended lit status and an intended un-lit status; and
display a graphic based at least in part on the intended illumination status of the at least one indicator of the remote vehicle using the display.

2. The system of claim 1, wherein:
the plurality of vehicle sensors further comprises an external camera; and
wherein to detect the remote vehicle in the environment surrounding the vehicle, the controller is further programmed to:
capture an image of the environment surrounding the vehicle using the external camera; and
identify the remote vehicle by analyzing the image.

3. The system of claim 2, wherein to determine the intended illumination status of the at least one indicator of the remote vehicle, the controller is further programmed to:
capture an image of the remote vehicle using the external camera;
identify an actual illumination status of a brake light of the remote vehicle using the image, wherein the actual illumination status includes an actual lit status and an actual un-lit status; and
determine the intended illumination status of the brake light of the remote vehicle to be the intended lit status in response to the brake light of the remote vehicle having the actual lit status.

4. The system of claim 1, wherein:
the plurality of vehicle sensors further comprises a vehicle communication system; and
wherein to detect the remote vehicle in the environment surrounding the vehicle, the controller is further programmed to:
receive a signal from the remote vehicle using the vehicle communication system; and
detect the remote vehicle based on the signal received from the remote vehicle.

5. The system of claim 4, wherein to determine the intended illumination status of the at least one indicator of the remote vehicle, the controller is further programmed to:
transmit a message to the remote vehicle using the vehicle communication system, wherein the message includes a request for the intended illumination status of the at least one indicator of the remote vehicle; and
receive a response from the remote vehicle using the vehicle communication system, wherein the response includes the intended illumination status of the at least one indicator of the remote vehicle.

6. The system of claim 1, wherein:
the plurality of vehicle sensors further comprises an electronic ranging sensor; and
wherein to detect the remote vehicle in the environment surrounding the vehicle, the controller is further programmed to:
measure a first object distance between the vehicle and an object in the environment surrounding the vehicle using the electronic ranging sensor; and
detect the remote vehicle based at least in part on the first object distance between the vehicle and the object in the environment surrounding the vehicle.

7. The system of claim 6, wherein to determine the intended illumination status of the at least one indicator of the remote vehicle, the controller is further programmed to:
measure a first remote vehicle velocity using the electronic ranging sensor;
wait for a predetermined delay time period;
measure a second remote vehicle velocity using the electronic ranging sensor;
determine an acceleration of the remote vehicle based at least in part on the first remote vehicle velocity, the second remote vehicle velocity and the predetermined delay time period; and
determine the intended illumination status of the at least one indicator of the remote vehicle based on the acceleration of the remote vehicle.

8. The system of claim 7, wherein to determine the intended illumination status of the at least one indicator of the remote vehicle based on the acceleration of the remote vehicle, the controller is further programmed to:
compare the acceleration of the remote vehicle to a predetermined acceleration threshold, wherein the predetermined acceleration threshold is less than zero; and
determine the intended illumination status of the at least one indicator of the remote vehicle to be the intended lit status in response to determining that the acceleration of the remote vehicle is less than or equal to the predetermined acceleration threshold.

9. The system of claim 1, wherein the display is an augmented reality head-up display (AR-HUD) system in electronic communication with the controller, wherein the AR-HUD system includes an occupant position tracking device and an AR-HUD projector, and wherein to display the graphic the controller is further programmed to:
determine a position of an occupant of the vehicle using the occupant position tracking device;
calculate a size, shape, and location of the graphic based on the position of the occupant and data from at least one of the plurality of vehicle sensors; and
display the graphic corresponding to the intended illumination status of the at least one indicator of the remote vehicle on a windscreen of the vehicle using the AR-HUD system based on the size, shape, and location of the graphic.

10. The system of claim 9, wherein the display further includes a transparent windscreen display (TWD) system in electronic communication with the controller, wherein the TWD system includes transparent phosphors embedded in the windscreen of the vehicle and a TWD projector, and wherein to display the graphic the controller is further programmed to:
calculate a size, shape, and location of the graphic based on data from at least one of the plurality of vehicle sensors; and
display the graphic corresponding to the intended illumination status of the at least one indicator of the remote vehicle on the windscreen of the vehicle using the TWD system based on the size, shape, and location of the graphic.

11. A method for displaying information upon a windscreen of a vehicle, the method comprising:
detecting a remote vehicle in an environment surrounding the vehicle using at least one of a plurality of vehicle sensors;
determining an acceleration of the remote vehicle using at least one of the plurality of vehicle sensors; and
displaying a graphic on the windscreen, wherein the graphic displayed is based at least in part on the acceleration of the remote vehicle.

12. The method of claim 11, wherein detecting the remote vehicle further comprises:
capturing an image of the environment surrounding the vehicle using an external camera; and
identifying the remote vehicle by analyzing the image.

13. The method of claim 12, wherein determining the acceleration of the remote vehicle further comprises:
capturing an image of the remote vehicle using the external camera;
identifying an illumination status of a brake light of the remote vehicle using the image, wherein the illumination status includes an illuminated status and a non-illuminated status; and
determining the acceleration of the remote vehicle to be negative in response to the brake light of the remote vehicle having an illuminated status.

14. The method of claim 11, wherein detecting the remote vehicle further comprises:
receiving a signal from the remote vehicle using a vehicle communication system; and
detecting the remote vehicle based on the signal received from the remote vehicle.

15. The method of claim 14, wherein determining the acceleration of the remote vehicle further comprises:
transmitting a message to the remote vehicle using the vehicle communication system, wherein the message includes a request for acceleration data of the remote vehicle; and
receiving a response from the remote vehicle using the vehicle communication system, wherein the response includes the acceleration of the remote vehicle.

16. The method of claim 11, wherein detecting the remote vehicle further comprises:
measuring a first object distance between the vehicle and an object in the environment surrounding the vehicle using an electronic ranging sensor; and
detecting the remote vehicle based at least in part on the first object distance between a front of the vehicle and the object in the environment surrounding the vehicle.

17. The method of claim 16, wherein determining the acceleration of the remote vehicle further comprises:
measuring a first remote vehicle velocity using the electronic ranging sensor;
waiting for a predetermined delay time period;
measuring a second remote vehicle velocity using the electronic ranging sensor; and
determining the acceleration of the remote vehicle based at least in part on the first remote vehicle velocity, the second remote vehicle velocity and the predetermined delay time period.

18. The method of claim 11 wherein displaying the graphic further comprises:
calculating a size, shape, and location of the graphic based on data from at least one of: an exterior camera and an occupant position tracking device; and
displaying the graphic corresponding to the acceleration of the remote vehicle on the windscreen of the vehicle using at least one of: a transparent windscreen display (TWD) system and an augmented reality head-up display (AR-HUD) system based on the size, shape, and location of the graphic.

19. A system for displaying information for a vehicle, the system comprising:
a plurality of vehicle sensors including an exterior camera, an electronic ranging sensor, and a vehicle communication system;
a display system including an augmented reality head-up display (AR-HUD) system and a transparent windscreen display (TWD) system; and
a controller in electrical communication with the plurality of vehicle sensors and the display system, wherein the controller is programmed to:
detect a remote vehicle in an environment surrounding the vehicle using at least one of the plurality of vehicle sensors;
determine an acceleration of the remote vehicle using at least one of the plurality of vehicle sensors;
compare the acceleration of the remote vehicle to a predetermined acceleration threshold, wherein the predetermined acceleration threshold is less than zero; and
display a graphic on a windscreen of the vehicle in response to determining that the acceleration of the remote vehicle is less than or equal to the predetermined acceleration threshold, wherein the graphic appears to be overlayed on the remote vehicle from a viewing perspective of an occupant of the vehicle, and wherein the graphic indicates that the remote vehicle is decelerating.

20. The system of claim 19, wherein to determine the acceleration of the remote vehicle, the controller is further programmed to:
attempt to establish a wireless vehicle-to-vehicle (V2V) connection to the remote vehicle;
determine a connection status of the attempt to establish the wireless V2V connection, wherein the connection status includes a successful connection status and an unsuccessful connection status;
transmit a message to the remote vehicle using the vehicle communication system in response to determining that the connection status is the successful connection status, wherein the message includes a request for acceleration data of the remote vehicle;
receive the acceleration of the remote vehicle using the vehicle communication system after transmitting the message to the remote vehicle;
measure a first remote vehicle velocity using the electronic ranging sensor in response to determining that the connection status is the unsuccessful connection status;
wait for a predetermined delay time period after measuring the first remote vehicle velocity;
measure a second remote vehicle velocity using the electronic ranging sensor after waiting for the predetermined delay time period; and
determine the acceleration of the remote vehicle based at least in part on the first remote vehicle velocity, the second remote vehicle velocity and the predetermined delay time period.
